(19) United States
(12) Patent Application Publication
(10) Pub. No.: US 2026/0122065 A1
(43) Pub. Date: Apr. 30, 2026

(54) COMMUNICATION DEVICE, NON-TRANSITORY COMPUTER-READABLE RECORDING MEDIUM STORING COMPUTER-READABLE INSTRUCTIONS FOR COMMUNICATION DEVICE, AND METHOD EXECUTED BY COMMUNICATION DEVICE

(71) Applicant: BROTHER KOGYO KABUSHIKI KAISHA, Nagoya (JP)

(72) Inventor: Seiya YOSHIDA, Nagoya (JP)

(21) Appl. No.: 19/370,110

(22) Filed: Oct. 27, 2025

(30) Foreign Application Priority Data
Oct. 30, 2024 (JP) 2024-191074

(51) Int. Cl. H04L 9/40; H04L 9/32; H04W 12/63; H04W 12/71

(52) U.S. Cl. CPC H04L 63/0861; H04L 9/3263; H04L 63/105; H04W 12/63; H04W 12/71

(57) ABSTRACT

A communication device may, in a case where an authentication start instruction is acquired, send, via a first communication interface, a first search signal including at least one authenticator information among a plurality of authenticator information in a memory. The communication device may receive, via the first communication interface, a first response signal from a first authenticator. The communication device may execute, via a second communication interface, encrypted communication using first communication information stored in association with first authenticator information and send, via the second communication interface, an authentication execution instruction to the first authenticator. The authentication execution instruction may be information for instructing to execute authentication according to a predetermined authentication scheme which uses a pair of keys and biometric authentication information.

### REFERENCE TO RELATED APPLICATION

This application claims priority to Japanese Patent Application No. 2024-191074 filed on October 30, 2024. The entire content of the priority application is incorporated herein by reference.

### BACKGROUND ART

A system including an image processing device, a terminal device, a FIDO server, and a cloud server is known. The image processing device displays a coded image. The terminal device captures the coded image, and sends ‘Advertising’ to the image processing device. When a BLE connection is established between the terminal device and the image processing device and biometric authentication succeeds, the terminal device executes CTAP communication with the image processing device. The image processing device sends an authentication request to the FIDO server.

### SUMMARY

The present teachings provide a novel and useful art to cause a communication device to execute authentication in accordance with a predetermined authentication scheme which uses a pair of keys and biometric authentication information.

The disclosure discloses a communication device. The communication device may comprise: a controller; a first communication interface configured to operate according to a first communication scheme; and a second communication interface configured to operate according to a second communication scheme different from the first communication scheme; and a memory configured to store, authenticator information and communication information in association with each other for each of a plurality of authenticators, wherein the authenticator information is related to the authenticator and the communication information is related to encrypted communication using the second communication interface between the authenticator and the communication device. The controller may be configured to: in a case where an authentication start instruction is acquired, send, via the first communication interface, a first search signal including at least one authenticator information among a plurality of the authenticator information in the memory; in response to the first search signal being sent, receive, via the first communication interface, a first response signal including first authenticator information included in the plurality of the authenticator information from a first authenticator related to the first authenticator information; and in a case where the first response signal is received, execute, via the second communication interface, the encrypted communication using first communication information stored in association with the first authenticator information and send, via the second communication interface, an authentication execution instruction to the first authenticator, wherein the authentication execution instruction is information for instructing to execute authentication according to a predetermined authentication scheme which uses a pair of keys and biometric authentication information.

According to the above configuration, the communication device sends the first search signal externally and receives the first response signal from the first authenticator via the first communication interface in the case where the communication device acquires the authentication start instruction. Next, the communication device sends the authentication execution instruction to the first authenticator by executing the encrypted communication using the first communication information via the second communication interface. Accordingly, the communication device can be caused to execute authentication according to the predetermined authentication scheme.

A non-transitory computer-readable recording medium storing computer-readable instructions for the above-described communication device and a method executed by the communication device are also novel and useful. Further, a communication system comprising the communication device and a plurality of authenticators is also novel and useful. Here, the above-described recording medium may be a single medium or plural media.

### BRIEF DESCRIPTION OF DRAWINGS

FIG. 1 illustrates a configuration of a communication system.

FIG. 2 illustrates examples of tables.

FIG. 3 illustrates a sequence diagram of Case A in which first link information is registered.

FIG. 4 is a continuation from FIG. 3.

FIG. 5 illustrates a sequence diagram of Case B in which second link information is registered.

FIG. 6 is a continuation from FIG. 5.

FIG. 7 illustrates a sequence diagram of Case C in which the first link information is used.

FIG. 8 illustrates a sequence diagram of Case D in which the first link information is used.

FIG. 9 illustrates a sequence diagram of Case E in which the first link information is used.

FIG. 10 illustrates a sequence diagram of Case F in which the first link information is used.

### DESCRIPTION

### First Embodiment

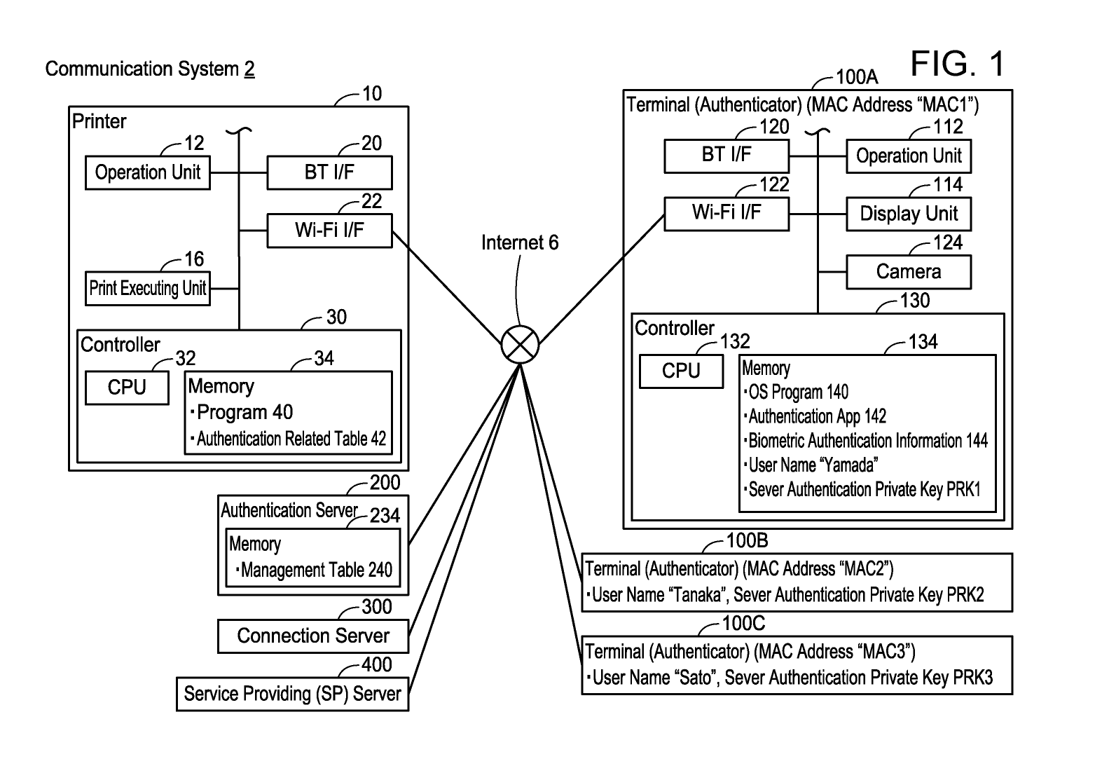

### Configuration of Communication System 2; FIG. 1

As illustrated in FIG. 1, a communication system 2 comprises a printer 10, a plurality of terminals 100A, 100B, 100C, an authentication server 200, a connection server 300, and a service providing server 400. Hereafter, the service providing server will be referred to as “SP server”. The printer 10, the plurality of terminals 100A, 100B, 100C, the authentication server 200, the connection server 300, and the SP server 400 are connected to the Internet 6. The printer 10, the plurality of terminals 100A, 100B, 100C, the authentication server 200, the connection server 300, and the SP server 400 are configured to communicate with each other via the Internet 6.

### Configuration of Printer 10

The printer 10 is a peripheral device configured to execute the print function (e.g., peripheral device for a PC, for example). The printer 10 is configured to operate in accordance with Fast Identity Online (FIDO) authentication scheme which uses a pair of keys and biometric authentication information. The FIDO authentication scheme is an authentication scheme which uses a pair of keys, i.e., a private key and a public key. Hereafter, the private key and the public key will be referred to as “server authentication private key” and “server authentication public key”. Also, the FIDO authentication scheme is an authentication scheme by which user authentication is executed by using biometric authentication information (e.g., fingerprint authentication information, voice authentication information, face authentication information) instead of authentication using a password. Hereafter, authentication according to the FIDO authentication scheme will be referred to as “FIDO authentication”.

The printer 10 comprises an operation unit 12, a print executing unit 16, a BT I/F 20, a Wi-Fi I/F 22, and a controller 30. Hereafter, the interface will be referred to as “I/F”. BT is abbreviation for “Bluetooth”. Here, Bluetooth is a registered trademark of Bluetooth SIG.

The operation unit 12 is a user interface which allows a user to input various information to the printer 10. The operation unit 12 comprises for example hardware key(s). The hardware key(s) include, for example, button(s) and/or switch(es).

The print executing unit 16 includes an electronic photo print engine, an inkjet print engine, or a thermal print engine. The inkjet print engine comprises a print head which ejects ink droplets. The electronic photo print engine comprises a photoreceptor and an exposure device which emits light to expose the photoreceptor. The thermal print engine comprises a print head which ejects heat with a heater.

The BT I/F 20 is an I/F configured to execute wireless communication according to a BT standard. Hereafter, the wireless communication according to the BT standard will be referred to as “BT communication”. The BT standard is IEEE802.15.1 standard and its subordinates, for example. More specifically, the BT I/F 20 supports Bluetooth Low Energy (BLE). BLE is realized by BT version 4.0 or its later versions.

The Wi-Fi I/F 22 is a wireless I/F for Wi-Fi communication according to a Wi-Fi standard. The Wi-Fi standard is a wireless communication standard for wireless communication according to, for example, 802.11 standard of the Institute of Electrical and Electronics Engineers, Inc. (IEEE) and standards in compliance therewith such as 802.11a, 11b, 11g, 11n, and 11ac. The Wi-Fi I/F 22 is configured to execute wireless communication according to a normal Wi-Fi scheme. Although this is an example, the wireless communication according to the normal Wi-Fi scheme is wireless communication for which an AP (not shown) is used. Hereafter, the wireless communication according to the normal Wi-Fi scheme will be referred to as “normal Wi-Fi communication”.

Here, difference(s) between the normal Wi-Fi communication and the BT communication will be described. As to communication speeds of each type of communication, the communication speed of the normal Wi-Fi communication (e.g., maximum communication speed is 600Mbps) and the communication speed of the BT communication (e.g., maximum communication speed is 24Mbps) are in descending order. As to a frequency of carrier wave in each type of communication, the frequency of carrier wave in the normal Wi-Fi communication is 2.4GHz band or 5.0GHz band, and the frequency of carrier wave in the BT communication is 2.4GHz band. That is, when 5.0GHz band is implemented as the frequency of the carrier wave for the normal Wi-Fi communication, the frequencies of the carrier waves will differ between the normal Wi-Fi communication and the BT communication. Also, as to the maximum distance over which each type of communication is possible, the maximum distance over which the normal Wi-Fi communication is possible (e.g., 100m) is greater than the maximum distance over which the BT communication is possible (e.g., several tens of meters). That is, the BT communication is so-called near field communication.

The Wi-Fi I/F 22 supports Wi-Fi Aware developed by the Wi-Fi Alliance. Details of Wi-Fi Aware are described in the specification called “Wi-Fi Aware Specification Version 4.0” created by the Wi-Fi Alliance. In the wireless communication according to Wi-Fi Aware, AP is not used. Hereafter, the wireless communication according to Wi-Fi Aware will be referred to as “Wi-Fi Aware communication”. Wi-Fi Aware is also called Wi-Fi Neighbor Awareness Network (NAN).

Each device which supports Wi-Fi Aware can join a NAN cluster of Wi-Fi Aware. Proximity information is sent and received between the devices which support Wi-Fi Aware. That is, wireless communication according to Wi-Fi Aware is so-called near field wireless communication.

The controller 30 comprises a CPU 32 and a memory 34. The memory 34 comprises a primary storage and an auxiliary storage. Although this is an example, the primary storage includes a RAM and cache memory. Although this is an example, the auxiliary storage may be a ROM, a flash memory, a Solid-State Drive (SSD), a Hard Disk Drive (HDD), or a combination thereof. In the auxiliary storage of the memory 34, a program 40 and an authentication related table 42 are stored. The CPU 32 realizes various processes in accordance with a program loaded from the auxiliary storage to the primary storage.

### Configurations of Terminals 100A to 100C

Each of the terminals 100A to 100C is a mobile terminal such as a mobile phone, a smartphone, a PDA, or a tablet PC. Each of the terminals 100A to 100C is configured to operate according to the FIDO authentication scheme. Each of the terminals 100A to 100C operates as a so-called authenticator in the FIDO authentication scheme.

The terminal 100A is assigned a MAC address “MAC1”. The terminal 100A comprises an operation unit 112, a display unit 114, a Wi-Fi I/F 122, a camera 124, and a controller 130.

The operation unit 112 is a user interface which allows a user to input various information to the terminal 100A. The operation unit 112 comprises a touch panel configured to display software key(s) (operation area), hardware key(s), or a both of them. The hardware key(s) include, for example, button(s) and/or switch(es). The display unit 114 is a display or a panel configured to display various information and/or screens to be described later. The display is for example a liquid crystal display or an organic EL display. The panel may be a touch panel or may not be a touch panel. The panel is for example a liquid crystal panel or an organic EL panel.

The BT I/F 120 has a same configuration as that of the BT I/F 20 of the printer 10. The Wi-Fi I/F 122 has a same configuration as that of the Wi-Fi I/F 22 of the printer 10.

The camera 124 is a device configured to capture images of an object. In the present embodiment, the camera 124 is used for capturing QR Code. QR Code is a registered trademark of DENSO WAVE INCORPORATED.

The controller 130 comprises a CPU 132 and a memory 134. The memory 134 comprises a primary storage and an auxiliary storage. The auxiliary storage of the memory 134 has an Operating System (OS) program 140, an authentication app 142, biometric authentication information 144, a user name “Yamada”, and a server authentication private key PRK1 stored therein. The OS program 140 controls basic operations of the terminal 100A. The authentication app 142 is a program configured to cause the terminal 100A to operate as an authenticator for FIDO authentication. The CPU 132 realizes various processes in accordance with a program loaded from the auxiliary storage to the primary storage. The biometric authentication information 144 is fingerprint information of a user who uses the terminal 100A. The user name “Yamada” is a user name of the user who uses the terminal 100A. Hereafter, the user who uses the terminal 100A will be referred to as “first user”. The server authentication private key PRK1 is a key used for the FIDO authentication. The user name “Yamada” and the server authentication private key PRK1 are registered in the memory 134 when a registration process for registering a pair of keys used for the FIDO authentication is executed.

The terminal 100B has a same configuration as that of the terminal 100A except that the terminal 10B is assigned a MAC address “MAC2” and a user name “Tanaka” and a server authentication private key PRK2 are stored in a memory (not shown) of the terminal 100B. Hereafter, a user who uses the terminal 100B will be referred to as “second user”.

The terminal 100C has a same configuration as that of the terminal 100A except that the terminal 100C is assigned a MAC address “MAC3” and a user name “Sato” and a server authentication private key PRK3 are stored in a memory (not shown) of the terminal 100C.

### Configurations of Servers 200, 300, 400

Each of servers 200, 300, 400 is a server disposed on the Internet 6. Each server 200, 300, 400 is a server provided by a vendor of the printer 10 for example. In a modification, each server 200, 300, 400 may be disposed on the Internet 6 by a business entity different from the vendor. In another modification, the vendor may not prepare hardware of each server 200, 300, 400 by themselves, but may use an environment provided by an external cloud computing service. In this case, the vendor may realize each server 200, 300, 400 by preparing a program (i.e., software) of each server 200, 300, 400 and introducing the program into the above-mentioned environment.

The authentication server 200 is configured to operate according to the FIDO authentication scheme. The authentication server 200 operates as a so-called authentication server in the FIDO authentication scheme. A memory 234 of the authentication server 200 has a management table 240 stored therein.

The connection server 300 relays communication between the printer 10 and a terminal. The connection server 300 is a server configured to provide a tunneling service.

The SP server 400 is configured to provide services related to the printer 10. Although this is an example, the SP server 400 provides a remote operating service, a print service. The remote operating service is a service which allows to operate the printer 10 via the SP server 400 by using a terminal. The print service is a service which allows to relay transmission of print data from a terminal to the printer 10. Although this is an example, the SP server 400 stores print data received from a terminal (upload process), and sends the print data to the printer 10 when receiving a download request for the print data from the printer 10 (download process).

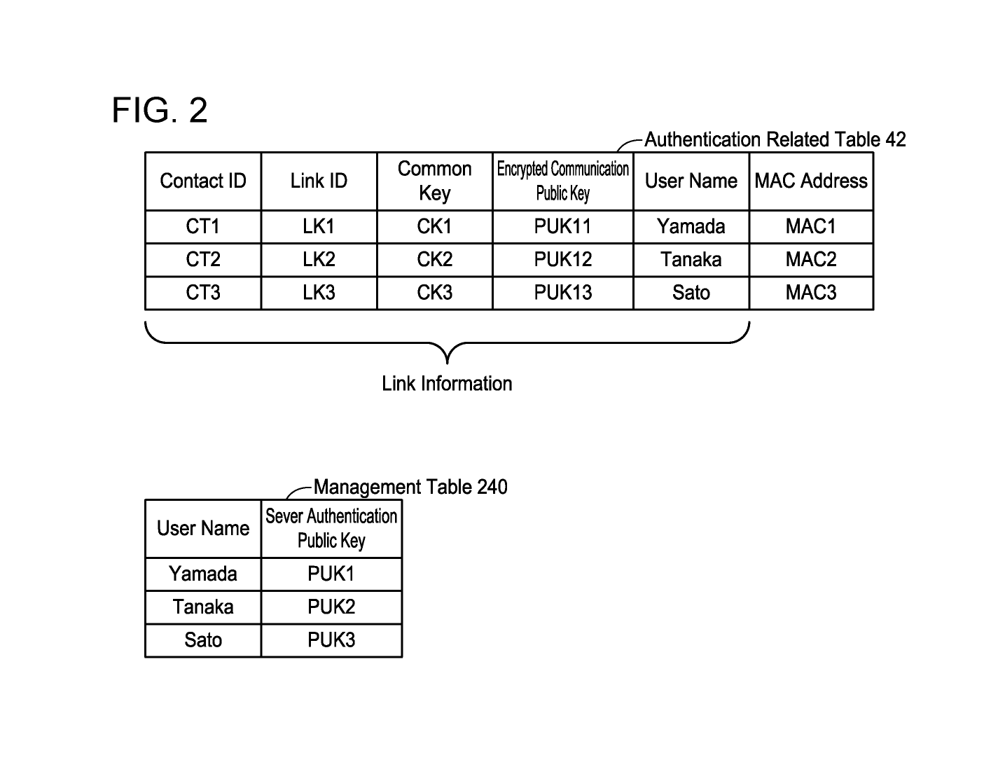

### Description for Respective Tables; FIG. 2

With reference to FIG. 2, the authentication related table 42 of the printer 10 and the management table 240 of the authentication server 200 will be described.

The authentication related table 42 of the printer 10 has link information and the MAC addresses stored in association with each other. The link information includes a contact ID, a link ID, a common key, an encrypted communication public key, and a user name. The contact ID is information for identifying an authenticator. The link ID is information for identifying the link information. The link information is information for using the tunneling service provided by the connection server 300. The encrypted communication public key is information used in an encrypted communication process to be described later.

The management table 240 of the authentication server 200 has a user name and a server authentication public key stored in association with each other. The server authentication public key is a key used for the FIDO authentication. The user name and the server authentication public key are registered in the management table 240 when a registration process for registering a pair of keys used for the FIDO authentication is executed.

### Specific Cases

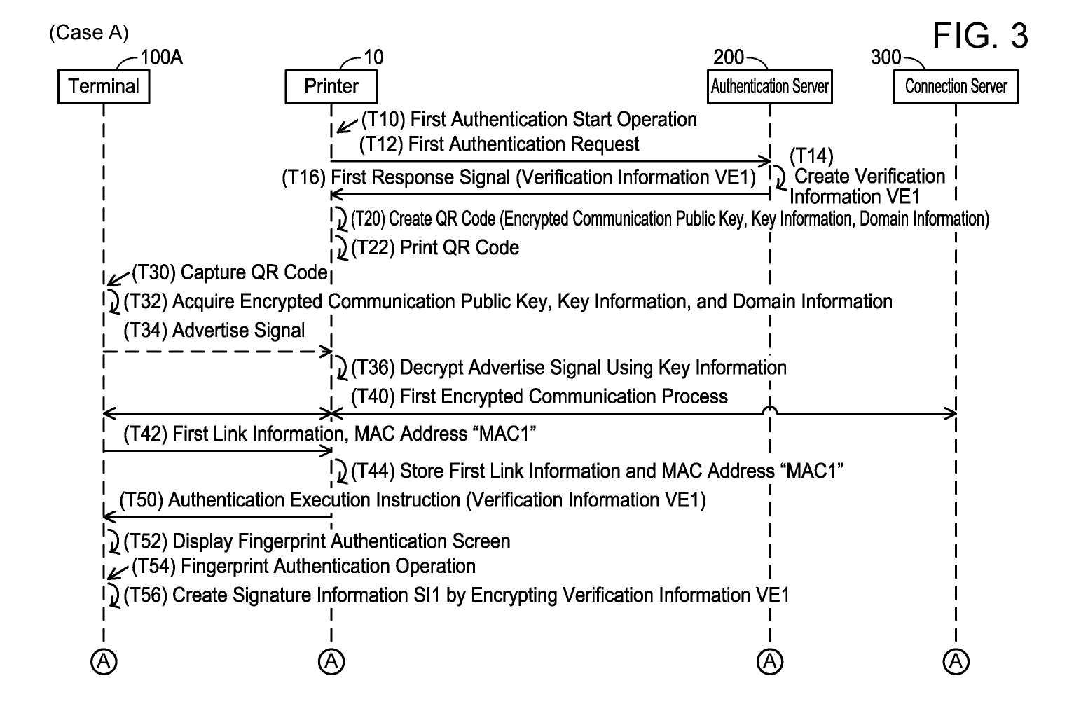

With reference to FIGS. 3 to 8, specific cases realized by the communication system 2 of the present embodiment will be described. Hereafter, description will be made with each device (e.g., the printer 10) as a subject of action, without describing the CPU of each device (e.g., the CPU 32 of the printer 10) as a subject of action. Further, in FIGS. 3 to 10, for easier understanding of types of communication used between the respective devices, the normal Wi-Fi communication is indicated in a thin solid line, the Wi-Fi Aware communication is indicated in a bold solid line, and the BT communication is indicated in a thin broken line.

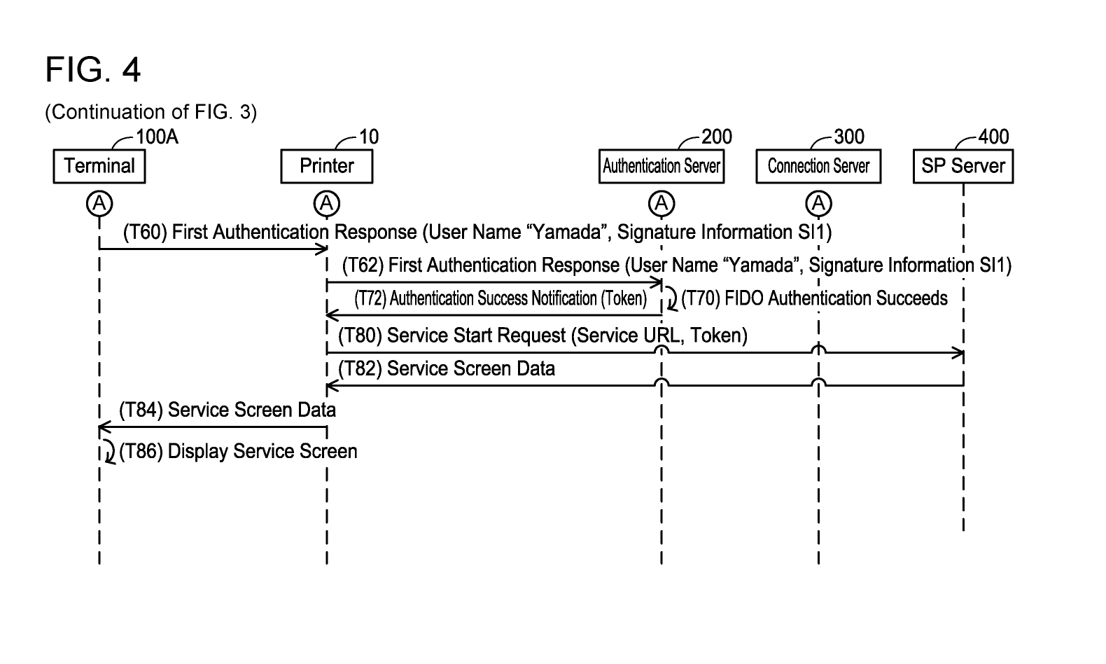

### Case A; FIGS. 3, 4

With reference to FIGS. 3, 4, Case A will be described. In Case A, first link information corresponding to the terminal 100A is registered in the authentication related table 42 of the printer 10. At an initial state of Case A, a combination of the user name “Yamada” and a server authentication public key PUK1, a combination of the user name “Tanaka” and a server authentication public key PUK2, and a combination of the user name “Sato” and a server authentication public key PUK3 are stored in the management table 240. The authentication related table 42 is empty. Also, the printer 10 and the terminal 100A belong to the same NAN cluster. That is, the printer 10 and the terminal 100A are configured to execute the Wi-Fi Aware communication.

In T10, the first user performs a first authentication start operation on the printer 10. The first authentication start operation is an operation for requesting execution of the FIDO authentication. In this case, the printer 10 determines that the authentication related table 42 is empty, that is, determines that the link information is not stored in the authentication related table 42, and sends a first authentication request to the authentication server 200 via the Wi-Fi I/F 22 by using the normal Wi-Fi communication in T12.

When the authentication server 200 receives the first authentication request from the printer 10 in T12, the authentication server 200 creates verification information VE1 and stores the verification information VE1 in T14. The authentication server 200 sends a first response signal including the verification information VE1 to the printer 10 in T16.

When the printer 10 receives the first response signal from the authentication server 200 via the Wi-Fi I/F 22 by using the normal Wi-Fi communication in T16, the printer 10 determines that the authentication related table 42 is empty. In this case, the printer 10 creates an encrypted communication public key, key information, domain information, and stores the respective information in the memory. The key information is information used for encryption/decryption of an Advertise signal. The domain information is information indicative of a tunneling service the printer 10 knows, and information indicative of a domain of a server which provides the tunneling service. The printer 10 creates QR Code acquired by coding the encrypted communication public key, the key information, and the domain information in T20. The printer 10 executes a print process of printing the created QR Code on a print paper in T22.

The first user captures the QR Code printed on the print paper by using the camera 124 of the terminal 100A in T30. The terminal 100A decodes the captured QR Code and acquires the encrypted communication public key, the key information, and the domain information in T32. The terminal 100A creates WebSocket information used for connecting with the connection server 300 and stores the WebSocket information in the memory 134. The WebSocket information includes a tunneling ID, a route ID, a tunneling service identifier. The tunneling ID and the route ID are information used for the tunneling service. The tunneling service identifier is information indicative of a server who provides the tunneling service to be used, that is, indicative of the connection server 300. The terminal 100A decides the tunneling service identifier by using the acquired domain information. The terminal 100A encrypts the created WebSocket information by using the acquired key information to create an Advertise signal. The terminal 100A sends the Advertise signal via the BT I/F 120 to the printer 10 in T34.

When the printer 10 receives the Advertise signal from the terminal 100A via the BT I/F 20 in T34, the printer 10 decrypts the Advertise signal by using the stored key information in T36. Due to this, the printer 10 acquires the WebSocket information. Subsequently, a first encrypted communication process for executing encrypted communication is executed between the terminal 100A, the printer 10, and the connection server 300 in T40. The first encrypted communication process includes a first connection process where the terminal 100A is connected to the connection server 300, a second connection process where the printer 10 is connected to the connection server 300, and a first handshake process where handshake is executed between the terminal 100A and the printer 10. In the first connection process, the tunneling service identifier is used. In the second connection process, the WebSocket information is used. In the first handshake process, the encrypted communication public key included in the QR Code is used. Due to this, a WebSocket connection is established between the terminal 100A and the printer 10. Also, the terminal 100A has become able to execute encrypted communication with the printer 10 via the connection server 300. Such encrypted communication is included in communication according to the normal Wi-Fi scheme.

When the first encrypted communication process ends, the terminal 100A creates first link information including a contact ID “CT1”, a link ID “LK1”, a common key CK1, an encrypted communication public key PUK11, and the user name “Yamada”, and stores the same in the memory 134. The encrypted communication public key PUK11 may be the same as or different from the encrypted communication public key in the QR Code. The terminal 100A sends the first link information and the MAC address “MAC1” via the Wi-Fi I/F 122 to the printer 10, by using the encrypted communication in T42. Here, the terminal 100A sends the contact ID “CT1” and the link ID “LK1” also to the connection server 300. Due to this, the connection server 300 becomes able to identify the terminal 100A by using the contact ID “CT1” and the link ID “LK1”.

When the printer 10 receives the first link information and the MAC address “MAC1” via the Wi-Fi I/F 22 from the terminal 100A by using the encrypted communication in T42, the printer 10 stores the first link information and the MAC address “MAC1” in the authentication related table 42 in T44. The printer 10 sends an authentication execution instruction including the acquired verification information VE1 (see T16) to the terminal 100A via the Wi-Fi I/F 22, by using the encrypted communication in T50. The authentication execution instruction is a signal for instructing to execute biometric authentication.

When the terminal 100A receives the authentication execution instruction from the printer 10 via the Wi-Fi I/F 22 by using the encrypted communication in T50, the terminal 100A displays a fingerprint authentication screen on the display unit 114 in T52. On the fingerprint authentication screen, a message requesting execution of fingerprint authentication is displayed. The first user performs a fingerprint authentication operation on the terminal 100A in T54. The terminal 100A determines that the fingerprint authentication has succeeded because fingerprint information acquired by the fingerprint authentication operation and the biometric authentication information 144 in the memory 134 match. In this case, the terminal 100A creates signature information SI1 by encrypting the received verification information VE1 by using the server authentication private key PRK1 in the memory 134 in T56. Also, the terminal 100A specifies the user name “Yamada” in the memory 134. The terminal 100A sends a first authentication response including the specified user name “Yamada” and the created signature information SI1 via the Wi-Fi I/F 122 to the printer 10 by using the encrypted communication in T60 of FIG. 4.

When the printer 10 receives the first authentication response from the terminal 100A via the Wi-Fi I/F 22 by using the encrypted communication in T60, the printer 10 sends the first authentication response to the authentication server 200 via the Wi-Fi I/F 22 in T62.

When the authentication server 200 receives the first authentication response from the printer 10 in T62, the authentication server 200 specifies the server authentication public key PUK1 stored in the management table 240 in association with the user name “Yamada” in the first authentication response. The authentication server 200 decrypts the signature information SI1 in the first authentication response by using the specified server authentication public key PUK1. Since the server authentication private key PRK1 and the server authentication public key PUK1 are a pair of keys, the verification information VE1 is acquired by decrypting the signature information SI1 with the server authentication public key PUK1. The authentication server 200 determines that the acquired verification information VE1 and the stored verification information VE1 (see T14 of FIG. 3) match, and determines that the FIDO authentication has succeeded in T70. In this case, the authentication server 200 sends an authentication success notification including a token to the printer 10 in T72. The token is authentication information shared between the authentication server 200 and the SP server 400. Here, the authentication server 200 sends an authentication failure notification indicating that the FIDO authentication has failed to the printer 10 when the authentication server 200 determines that the FIDO authentication does not succeed.

When the printer 10 receives the authentication success notification from the authentication server 200 via the Wi-Fi I/F 22 in T72, the printer 10 specifies the token in the authentication success notification. The printer 10 sends a service start request including a service URL and the specified token to the SP server 400 in T80. The service URL is information indicative of a location of the SP server 400 on the Internet 6.

When the SP server 400 receives the service start request from the printer 10 in T80, the SP server 400 sends service screen data to the printer 10 in T82.

When the printer 10 receives the service screen data from the SP server 400 via the Wi-Fi I/F 22 in T82, the printer 10 sends the service screen data to the terminal 100A via the Wi-Fi I/F 22 by using the encrypted communication in T84.

When the terminal 100A receives the service screen data from the printer 10 via the Wi-Fi I/F 122 by using the encrypted communication in T84, the terminal 100A displays a service screen represented by the service screen data on the display unit 114 in T86. The service screen is a screen for using a remote operation screen. In a modification, the service screen may be a screen for selecting print data to be printed by the printer 10.

The printer 10 does not execute the process of T80 when the printer 10 receives the authentication failure notification from the authentication server 200 after sending the first authentication response to the authentication server 200.

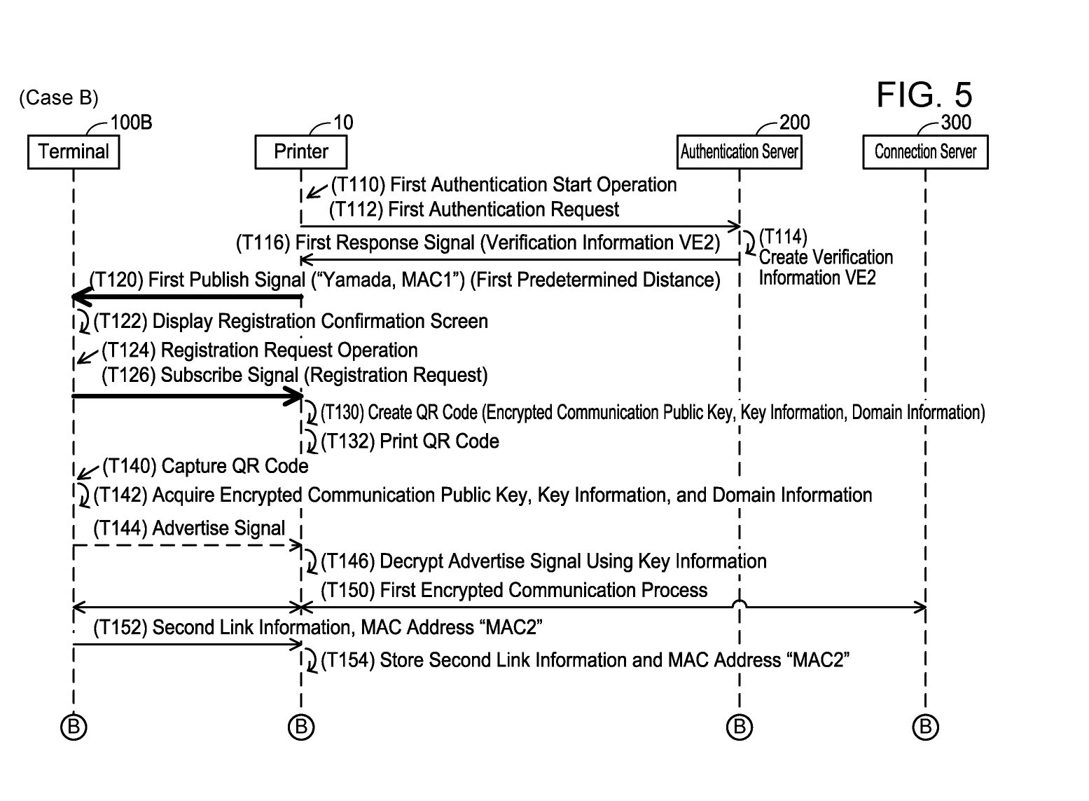

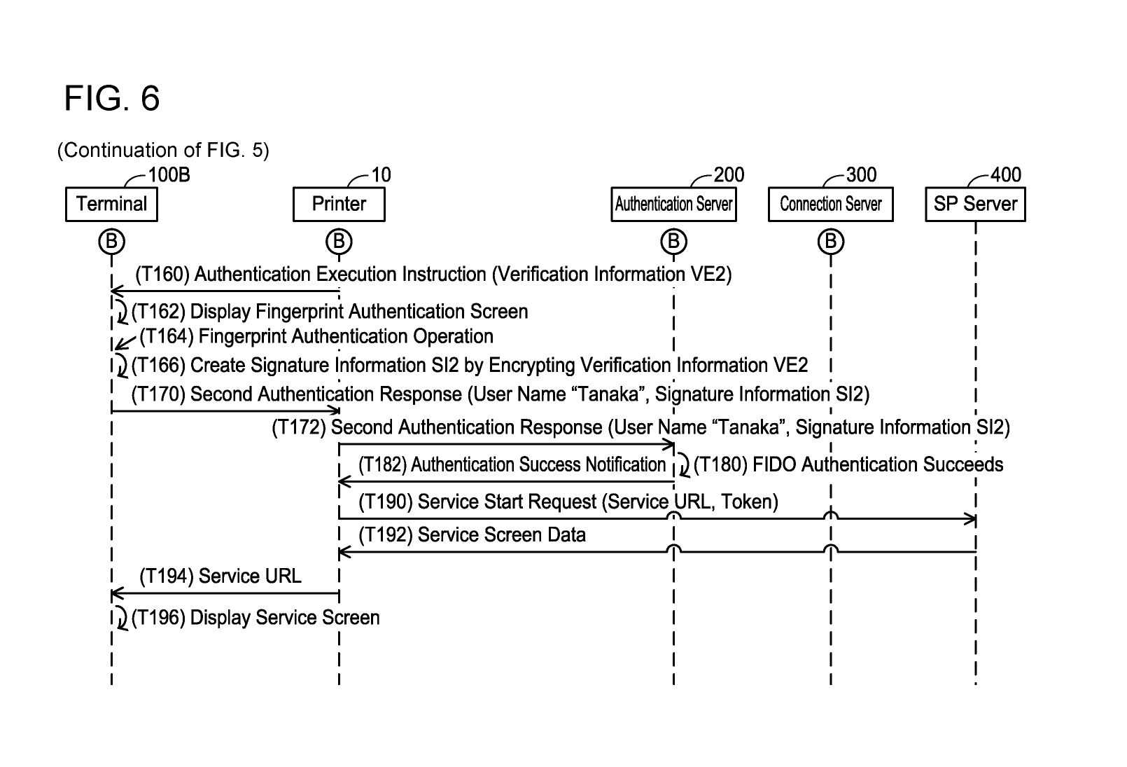

### Case B; FIGS. 5, 6

With reference to FIGS. 5, 6, Case B will be described. In Case B, second link information corresponding to the terminal 100B is registered in the authentication related table 42 of the printer 10. An initial state of Case B is the state after the initial state of Case A. In Case B, the printer 10 and the terminal 100B belong to the same NAN cluster. In Case B, a distance between the printer 10 and the terminal 100B is less than a first predetermined distance. Although this is an example, the first predetermined distance is 5m.

T110 to T116 are the same as T10 to T16 of FIG. 3 except that the verification information VE2 is used instead of the verification information VE1. When the printer 10 receives the first response signal from the authentication server 200 via the Wi-Fi I/F 22 by using the normal Wi-Fi communication in T116, the printer 10 determines that the authentication related table 42 includes the link information. In this case, the printer 10 specifies the combination of the user name “Yamada” and the MAC address “MAC1” in the authentication related table 42, and sends a first Publish signal including “Yamada, MAC1” via the Wi-Fi I/F 22 by using the Wi-Fi Aware communication in T120. The first Publish signal is a signal directed to an authenticator of which distance from the printer 10 is less than the first predetermined distance.

When the terminal 100B receives the first Publish signal from the printer 10 via the Wi-Fi I/F by using the Wi-Fi Aware communication in T120, the terminal 100B measures the distance from the printer 10 by using a distance measurement function (Wi-Fi RTT function) according to Wi-Fi Aware. In the present case, the distance between the printer 10 and the terminal 100B is less than the first predetermined distance. Due to this, the terminal 100B determines that the first Publish signal is a signal directed to the terminal 100B, and determines whether the first Publish signal includes the MAC address “MAC2” of the terminal 100B or not. Subsequently, the terminal 100B determines that the first Publish signal does not include the MAC address “MAC2”. In this case, the terminal 100B displays a registration confirmation screen on its display unit in T122. The registration confirmation screen is a screen for confirming whether to execute the FIDO authentication. The second user performs a registration request operation on the terminal 100B in T122. Due to this, the terminal 100B sends a Subscribe signal including a registration request to the printer 10 via the Wi-Fi I/F by using the Wi-Fi Aware communication in T126.

When the printer 10 receives the Subscribe signal from the terminal 100B via the Wi-Fi I/F 22 by using the Wi-Fi Aware communication in T126, the printer 10 creates encrypted communication public key, the key information, the domain information. T130, T132 are respectively the same as T20, T22 of FIG. 3.

The second user captures the QR Code printed on the print paper by using a camera of the terminal 100B in T140. The terminal 100B decodes the captured QR Code and acquires the encrypted communication public key, the key information, the domain information in T142. The terminal 100B creates the WebSocket information. The terminal 100B encrypts the created WebSocket information by using the acquired key information, and creates the Advertise signal. The terminal 100B sends the Advertise signal to the printer 10 via the BT I/F in T144.

When the printer 10 receives the Advertise signal from the terminal 100B via the BT I/F 20 in T144, the printer 10 decrypts the Advertise signal by using the key information in T146. Due to this, the printer 10 acquires the WebSocket information. In T150, the first encrypted communication process is executed between the terminal 100B, the printer 10, and the connection server 300. A content of the first encrypted communication process in T150 is the same as that of the first encrypted communication process in T40 of FIG. 3 except that the communication target is the terminal 100B.

The terminal 100B creates the second link information including a contact ID “CT2”, a link ID “LK2”, a common key CK2, encrypted communication public key PUK12, and the user name “Tanaka”, and stores the same in the memory. The terminal 100B sends the second link information and the MAC address “MAC2” to the printer 10 via the Wi-Fi I/F by using the encrypted communication in T152.

When the printer 10 receives the second link information and the MAC address “MAC2” from the terminal 100B via the Wi-Fi I/F 22 by using the encrypted communication in T152, the printer 10 stores the second link information and the MAC address “MAC2” in the authentication related table 42 in T154. The printer 10 sends the authentication execution instruction including the acquired verification information VE2 (T116 of FIG. 5) to the terminal 100B via the Wi-Fi I/F 22 by using the encrypted communication in T160 of FIG. 6.

When the terminal 100B receives the authentication execution instruction from the printer 10 via the Wi-Fi I/F by using the encrypted communication in T160, the terminal 100B displays the fingerprint authentication screen on its display unit in T162. The second user performs the fingerprint authentication operation on the terminal 100B in T164. The terminal 100B determines that the fingerprint authentication has succeeded because the fingerprint information acquired by the fingerprint authentication operation and the biometric authentication information in the memory match. In this case, the terminal 100B creates signature information SI2 by encrypting the received verification information VE2 with the server authentication private key PRK2 in the memory in T166. Also, the terminal 100B specifies the user name “Tanaka” in the memory. The terminal 100B sends a second authentication response including the specified user name “Tanaka” and the created signature information SI2 to the printer 10 via the Wi-Fi I/F by using the encrypted communication in T170.

When the printer 10 receives the second authentication response from the terminal 100B via the Wi-Fi I/F 22 by using the encrypted communication in T170, the printer 10 sends the second authentication response to the authentication server 200 via the Wi-Fi I/F 22 in T172.

When the authentication server 200 receives the second authentication response from the printer 10 in T172, the authentication server 200 executes a process using the server authentication public key PUK2 which is stored in the management table 240 in association with the user name “Tanaka” in the second authentication response. Due to this, the authentication server 200 determines that the FIDO authentication has succeeded in T180. In this case, the authentication server 200 sends the authentication success notification including a token to the printer 10 in T182.

T190 to T196 are the same as T80 to T86 of FIG. 4 except that the communication target is the terminal 100B.

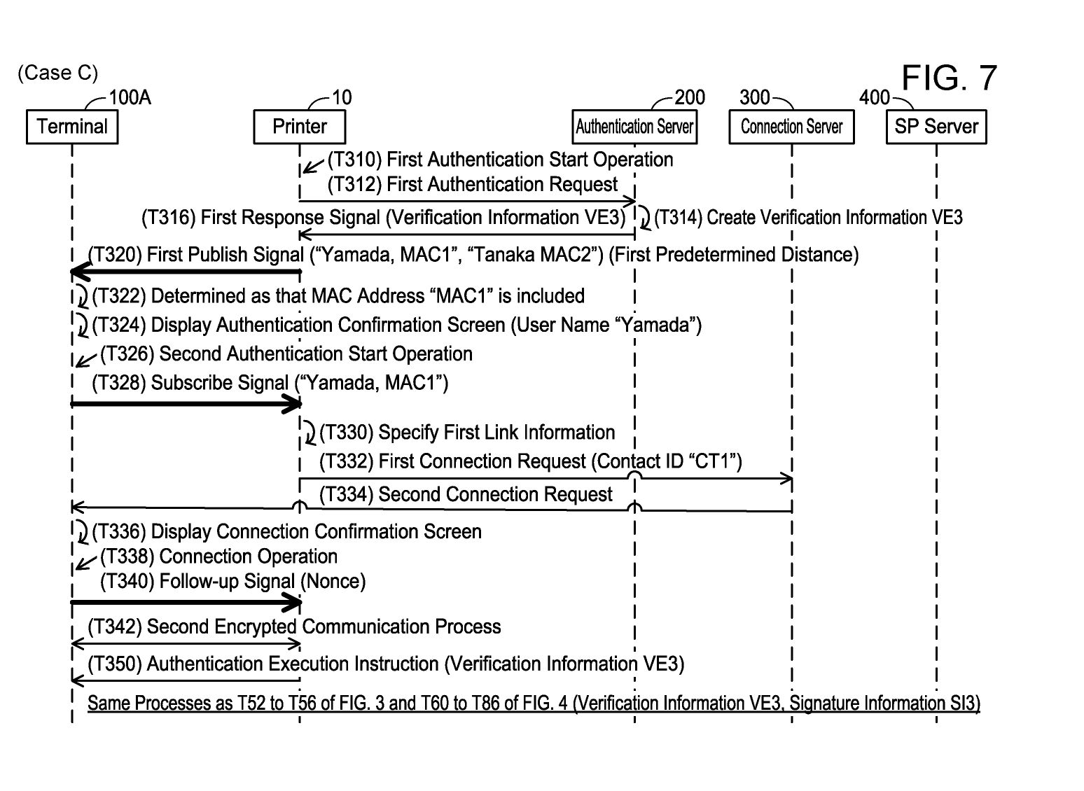

### Case C; FIG. 7

With reference to FIG. 7, Case C will be described. In Case C, by using the first link information, connection using encrypted communication is established between the terminal 100A and the printer 10. Case C is a state after Case B of FIGS. 5, 6. That is, the combination of the first link information and the MAC address “MAC1” and the combination of the second link information and the MAC address “MAC2” are stored in the authentication related table 42 of the printer 10. In Case C, the printer 10 and the terminal 100A belong to the same NAN cluster. In Case C, the distance between the printer 10 and the terminal 100A is less than the first predetermined distance.

T310 to T316 are the same as T10 to T16 of FIG. 3 except that verification information VE3 is used instead of the verification information VE1. When the printer 10 receives the first response signal from the authentication server 200 via the Wi-Fi I/F 22 by using the normal Wi-Fi communication in T316, the printer 10 determines that the authentication related table 42 includes the link information. In this case, the printer 10 specifies the combinations of the user name “Yamada” and the MAC address “MAC1”, and the user name “Tanaka” and the MAC address “MAC2” in the authentication related table 42. The printer 10 sends the first Publish signal including “Yamada, MAC1” and “Tanaka, MAC2” via the Wi-Fi I/F 22 by using the Wi-Fi Aware communication in T320. As such, the first Publish signal includes the user name(s) included in all the authentication information included in the authentication related table 42 and the MAC address(es) stored in association with those user name(s).

When the terminal 100A receives the first Publish signal from the printer 10 via the Wi-Fi I/F by using the Wi-Fi Aware communication in T320, the terminal 100A measures the distance from the printer 10 by using the distance measurement function according to Wi-Fi Aware. In the present case, the distance between the printer 10 and the terminal 100A is less than the first predetermined distance. Due to this, the terminal 100A determines that the first Publish signal is a signal directed to the terminal 100A, and determines whether the first Publish signal includes the MAC address “MAC1” or not. The terminal 100A determines that the first Publish signal includes the MAC address “MAC1” in T322. In this case, the terminal 100A displays an authentication confirmation screen including the user name “Yamada” corresponding to the MAC address “MAC1” on the display unit 114 in T324. The authentication confirmation screen is a screen for confirming whether to execute the FIDO authentication. The first user performs a second authentication start operation for instructing to execute the FIDO authentication on the terminal 100A in T326. Due to this, the terminal 100A sends the Subscribe signal including “Yamada, MAC1” to the printer 10 via the Wi-Fi I/F 122 by using the Wi-Fi Aware communication in T328.

When the printer 10 receives the Subscribe signal from the terminal 100A via the Wi-Fi I/F 22 by using the Wi-Fi Aware communication in T328, the printer 10 specifies the first link information associated with the MAC address “MAC1” in the Subscribe signal in the authentication related table 42 in T330. The printer 10 specifies the contact ID “CT1” in the first link information. The printer 10 sends a first connection request including the contact ID “CT1” to the connection server 300 via the Wi-Fi I/F 22 in T332.

When the connection server 300 receives the first connection request from the printer 10 in T332, the connection server 300 specifies the contact ID “CT1” in the first connection request, and specifies the terminal 100A that is identified by the contact ID “CT1”. The connection server 300 sends a second connection request to the terminal 100A in T334.

When the terminal 100A receives the second connection request from the connection server 300 via the Wi-Fi I/F 122 by using the normal Wi-Fi communication in T334, the terminal 100A displays a connection confirmation screen on the display unit 114 in T336. The connection confirmation screen is a screen for confirming whether to establish a connection for executing encrypted communication between the terminal 100A and the printer 10. The first user performs a connection operation on the terminal 100A in T338. Due to this, the terminal 100A sends a Follow-up signal including “nonce” to the printer 10 via the Wi-Fi I/F 122 by using the Wi-Fi Aware communication. Such Follow-up signal is a signal indicating that the terminal 100A is proximate the printer 10. Here, in a modification, the process of T340 may be omitted.

A second encrypted communication process is executed between the terminal 100A and the printer 10 in T342. In the second encrypted communication process, the encrypted communication public key in the first link information is used. Due to this, the WebSocket connection is established between the terminal 100A and the printer 10. Also, the terminal 100A becomes able to execute encrypted communication with the printer 10 via the connection server 300. The printer 10 sends the authentication execution instruction including the acquired verification information VE3 (see T314) to the terminal 100A via the Wi-Fi I/F 22 by using the encrypted communication in T350. Thereafter, the same processes as T52 to T56 of FIG. 3, T60 to T86 of FIG. 4 are executed between the terminal 100A, the printer 10, the authentication server 200, and the SP server 400. In the present case, the verification information VE3 and signature information SI3 are used.

As mentioned above, the first Publish signal is a signal directed to a terminal of which distance from the printer 10 is less than the first predetermined distance. According to such configuration, the FIDO authentication can be executed using the terminal proximate the printer 10.

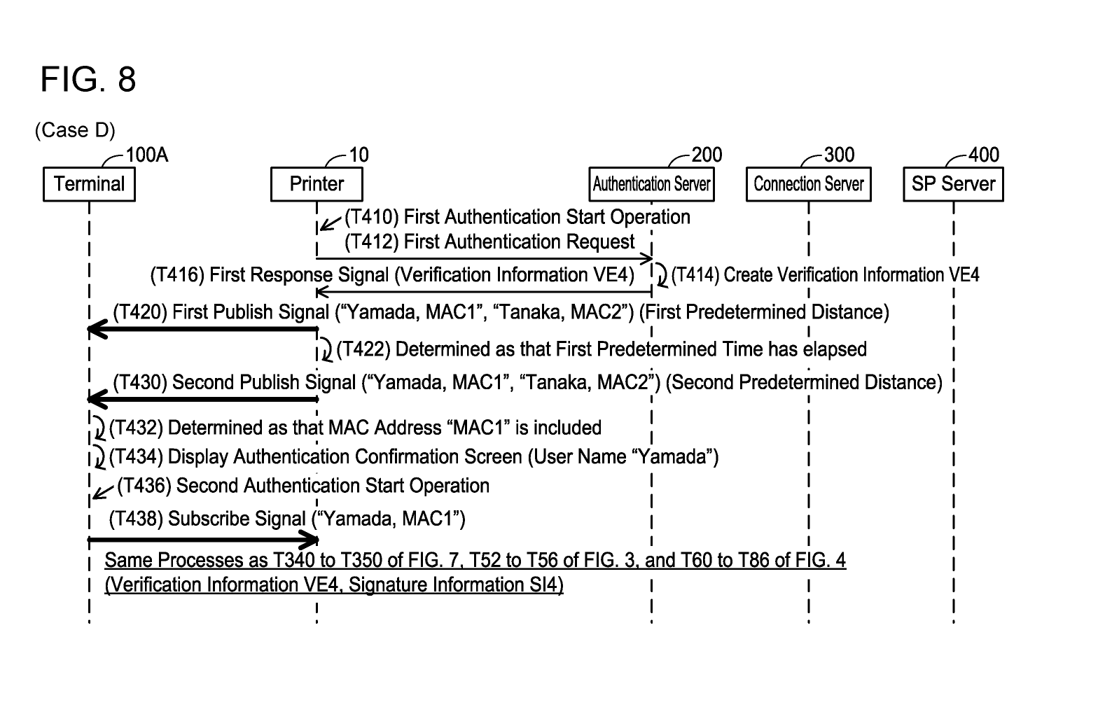

### Case D; FIG. 8

With reference to FIG. 8, Case D will be described. In Case D, by using the first link information, a connection using encrypted communication is established between the terminal 100A and the printer 10. An initial state of Case D is the same as the initial state of Case C of FIG. 7. In Case D, the printer 10 and the terminal 100A belong to the same NAN cluster. In Case D, a distance between the printer 10 and the terminal 100A is less than a second predetermined distance which is greater than the first predetermined distance. Although this is an example, the second predetermined distance is 10m.

T410 to T416 are the same as T10 to T16 of FIG. 3 except that verification information VE4 is used instead of the verification information VE1. T420 is the same as T320 of FIG. 7. In the present case, the terminal 100A determines that the distance between the printer 10 and the terminal 100A is greater than the first predetermined distance, and determines that the first Publish signal is not a signal directed to the terminal 100A. In this case, the terminal 100A does not determine whether the first Publish signal includes the MAC address “MAC1” or not. That is, the terminal 100A does not send the Subscribe signal including “Yamada, MAC1” as a response to the first Publish signal.

The printer 10 determines that a time for which the printer 10 does not receive the Subscribe signal since the printer 10 sent the first Publish signal has reached a first predetermined time in T422. In this case, the printer 10 sends a second Publish signal including “Yamada, MAC1” and “Tanaka, MAC2” via the Wi-Fi I/F 22 by using the Wi-Fi Aware communication in T430. The second Publish signal is a signal directed to an authenticator of which distance from the printer 10 is less than the second predetermined distance.

When the terminal 100A receives the second Publish signal from the printer 10 via the Wi-Fi I/F 22 by using the Wi-Fi Aware communication in T430, the terminal 100A determines that a distance between the printer 10 and the terminal 100A is less than the second predetermined distance. Due to this, the terminal 100A determines that the second Publish signal is the signal directed to the terminal 100A, and determines whether the second Publish signal includes the MAC address “MAC1” or not. The terminal 100A determines that the second Publish signal includes the MAC address “MAC1” in T432. T434 to T438 are the same as T324 to T328 of FIG. 7. Thereafter, the same processes as T340 to T350 of FIG. 7, T52 to T56 of FIG. 3, and T60 to T86 of FIG. 4 are executed between the terminal 100A, the printer 10, the authentication server 200, the connection server 300, and the SP server 400. In the present case, the verification information VE4 and signature information SI4 are used.

As mentioned above, when a first Subscribe signal is not received after the first Publish signal has been sent, the printer 10 sends the second Publish signal including “Yamada, MAC1” and “Tanaka, MAC2” via the Wi-Fi I/F 22 by using the Wi-Fi Aware communication (T430). According to such configuration, even when the terminal 100A is not within a range in which the distance from the printer 10 is the first predetermined distance, the FIDO authentication using the terminal 100A can be executed.

### Effects by Present Embodiment

According to the above configuration, when the printer 10 acquires an authentication start instruction (T310 of FIG. 7), the printer 10 sends the first Publish signal to an external device via the Wi-Fi I/F 22 according to Wi-Fi Aware (T320), the printer 10 receives the Subscribe signal from the terminal 100A via the Wi-Fi I/F 22 according to Wi-Fi Aware (T328). Next, the printer 10 executes encrypted communication using the first link information to send the authentication execution instruction to the terminal 100A via the Wi-Fi I/F 22 according to the normal Wi-Fi scheme (T350). Accordingly, execution of the FIDO authentication can be caused.

### Correspondence Relationships

The printer 10 is an example of “communication device”. Wi-Fi Aware and the Wi-Fi I/F 22 configured to operate according to Wi-Fi Aware are respectively examples of “first communication scheme”, “first communication interface”. The normal Wi-Fi scheme and the Wi-Fi I/F 22 configured to operate according to the normal Wi-Fi scheme are respectively examples of “second communication scheme”, “second communication interface”. The terminals 100A to 100C are an example of “plurality of authenticators”. The MAC address is an example of “authenticator information”. The link information is an example of “communication information”. The first Publish signal in FIGS. 7, 8 is an example of “first search signal”. The terminal 100A is an example of “first authenticator”. The MAC address “MAC1” is an example of “first authenticator information”. The Subscribe signal in T328 of FIG. 7 is an example of “first response signal”. The first link information is an example of “first communication information”. The FIDO authentication is an example of “authentication according to a predetermined authentication scheme”. The second Publish signal of FIG. 8 is an example of “second search signal”. The terminal 100A is an example of “second authenticator”. The MAC address “MAC1” is an example of “second authenticator information”. The Subscribe signal in T438 of FIG. 8 is an example of “second response signal”. The BT I/F 20 is an example of “third communication interface”. The ADV signal in T34 of FIG. 4 is an example of “third communication information”.

T320 of FIG. 7, T420 of FIG. 8 are an example executed by “send, via the first communication interface, a first search signal”. T328 of FIG. 7 is an example of a process executed by “receive, via the first communication interface, a first response signal”. T350 of FIG. 7 is an example of a process executed by “execute, via the second communication interface, the encrypted communication”.

### Second Embodiment

A second embodiment will be described. In the second embodiment, the contents of the processes executed by the printer 10 when the link information is stored in the authentication related table 42 are different from those of the first embodiment.

### Specific Case

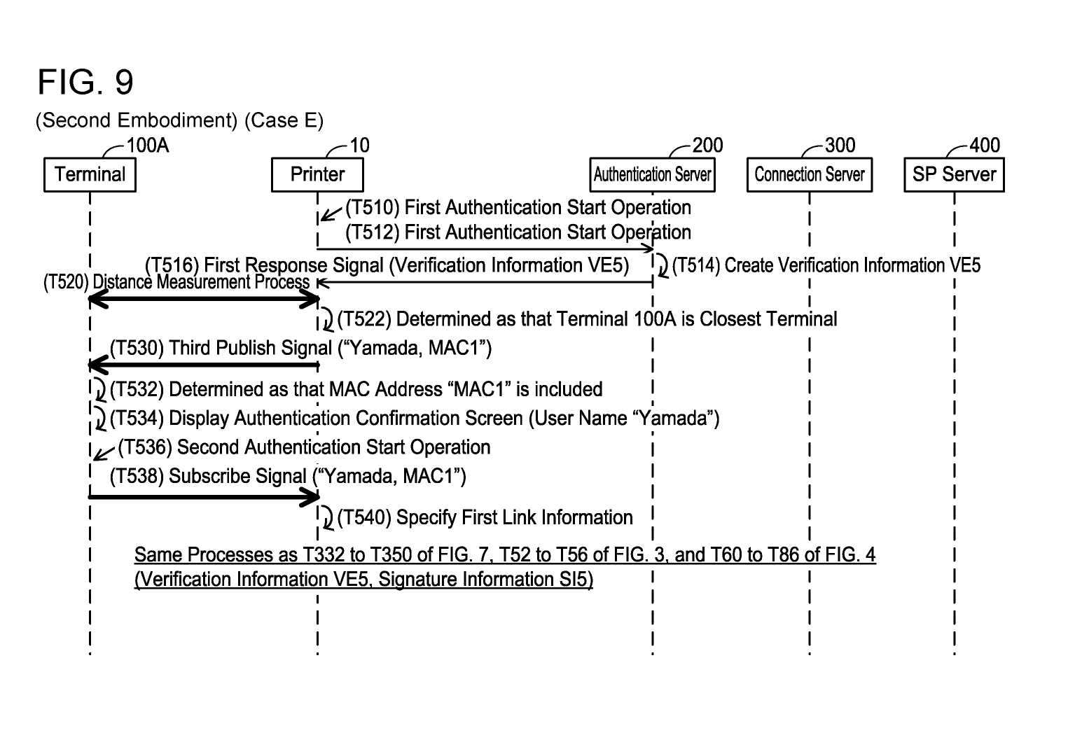

With reference to FIG. 9, a specific case realized by the communication system 2 of the present embodiment will be described.

### Case E; FIG. 9

With reference to FIG. 9, Case E will be described. In Case E, a connection using encrypted communication is established between the terminal 100A and the printer 10, by using the first link information. An initial state of Case E is the same as the initial state of Case C of FIG. 7. In Case E, the printer 10 and the terminals 100A to 100C belong to the same NAN cluster.

T510 to T516 are the same as T10 to T16 of FIG. 3 except that verification information VE5 is used instead of the verification information VE1. The printer 10 executes a distance measurement process of measuring a distance from each of the terminals 100A to 100C by using the distance measurement function according to Wi-Fi Aware in T520. Next, the printer 10 specifies the terminal which is at the shortest distance from the printer 10 from among the distances between the printer 10 and the terminals 100A to 100C. Hereafter, the terminal which is at the shortest distance from the printer 10 will be referred to as “most proximate terminal”. In the present case, the printer 10 determines that the terminal 100A is the most proximate terminal in T522, and determines that the MAC address “MAC1” of the terminal 100A is already stored in the authentication related table 42. In this case, the printer 10 sends the third Publish signal including “Yamada, MAC1” via the Wi-Fi I/F 22 by using the Wi-Fi Aware communication. The third Publish signal is a signal directed to the most proximate terminal. Here, when the MAC address of the most proximate terminal is not stored in the authentication related table 42, the printer 10 sends a fourth Publish signal including registration confirmation screen data to the most proximate terminal. In this case, processes from T122 of FIG. 5 are executed.

T532 to T540 are the same as T322 to T330 of FIG. 7. Thereafter, the same processes as T340 to T350 of FIG. 7, T52 to T56 of FIG. 3, and T60 to T86 of FIG. 4 are executed between the terminal 100A, the printer 10, the authentication server 200, the connection server 300, and the SP server 400. In the present case, the verification information VE5 and signature information SI5 are used.

As mentioned above, the printer 10 selects the terminal 100A which is at the shortest distance from the printer 10 from among the plurality of terminals 100A to 100C, and sends the third Publish signal to the selected terminal 100A. It is likely that the user who is using the terminal which is at the shortest distance from the printer 10 wishes to execute the FIDO authentication. According to the above configuration, the FIDO authentication can be executed by using the terminal which the user with a high likelihood of wishing to execute the FIDO authentication is using.

### Correspondence Relationships

The third Publish signal is an example of “first search signal”.

### Third Embodiment

A third embodiment will be described. In the third embodiment, the contents of processes executed by the printer 10 when the link information is stored in the authentication related table 42 are different from those of the first embodiment.

### Specific Case

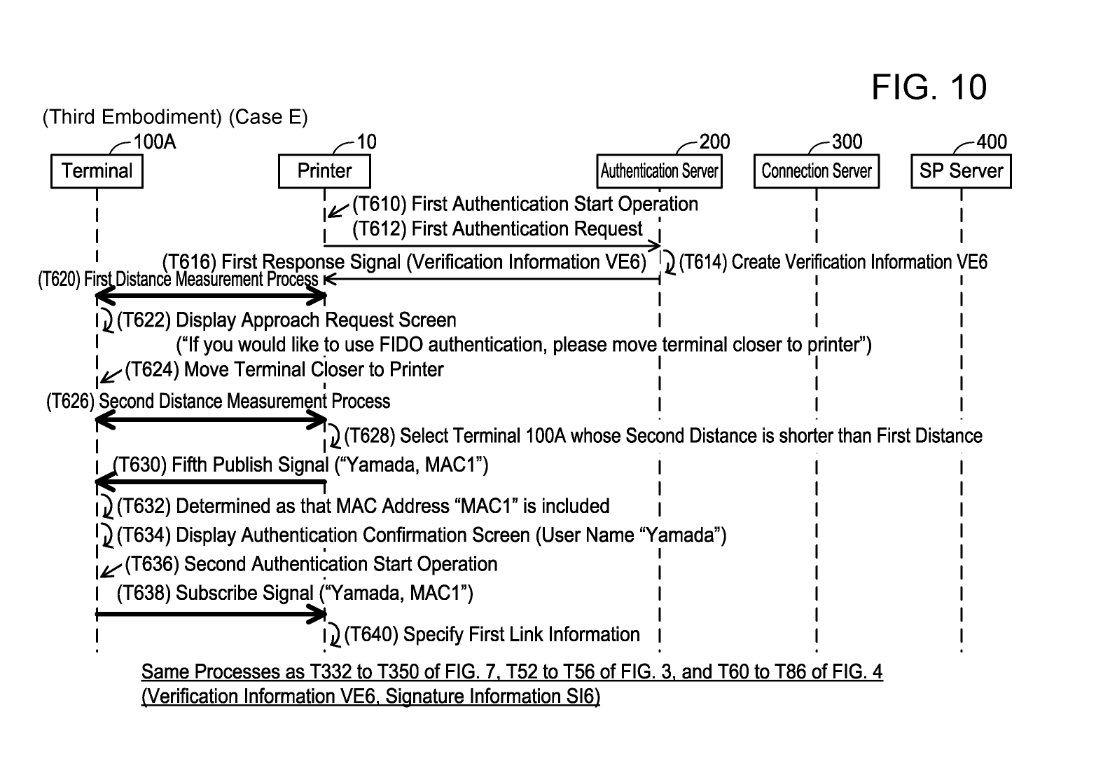

With reference to FIG. 10, a specific case realized by the communication system 2 of the present embodiment will be described.

### Case F; FIG. 10

With reference to FIG. 10, Case F will be described. In Case F, a connection using encrypted communication is established between the terminal 100A and the printer 10 by using the first link information. An initial state of Case F is the same as the initial state of Case C of FIG. 7. In Case F, the printer 10 and the terminals 100A to 100C belong to the same NAN cluster.

T610 to T616 are the same as T10 to T16 of FIG. 3 except that verification information VE6 is used instead of the verification information VE1. The printer 10 executes a first distance measurement process of measuring a first distance from each of the terminals 100A to 100C by using the distance measurement function according to Wi-Fi Aware in T620.

The terminal 100A displays an approach request confirmation screen on the display unit 114 in T622. The approach request confirmation screen includes a message “If you would like to use FIDO authentication, please move terminal closer to printer.” Here, the similar screen is displayed also on the terminals 100B, 100C. In the present case, the first user moves the terminal 100A closer to the printer 10 in T624.

The printer 10 determines that a second predetermined time has elapsed since execution of the first distance measurement process, and by using the distance measurement function according to Wi-Fi Aware, executes a second distance measurement process of measuring a second distance from each of the terminals 100A to 100C in T626. The printer 10 selects the terminal 100A whose second distance is smaller than its own first distance from among the terminals 100A to 100C, and specifies the combination of the user name “Yamada” and the MAC address “MAC1” in the authentication related table 42 in T628. The printer 10 sends a fifth Publish signal including “Yamada, MAC1” via the Wi-Fi I/F 22 by using the Wi-Fi Aware communication in T630. Here, if there are plural terminals whose second distance is smaller than their first distance, the printer 10 may send the fifth Publish signal including the user names and the MAC addresses corresponding to these plural terminals. In another modification, if there are plural terminals whose second distance is smaller than their first distance, the printer 10 may select the terminal whose second distance is the shortest from among the plural terminals, and may send the fifth Publish signal including the user name and the MAC address corresponding to the selected terminal.

T632 to T640 are the same as T322 to T330 of FIG. 7. Thereafter, the same processes as T340 to T350 of FIG. 7, T52 to T56 of FIG. 3, and T60 to T86 of FIG. 4 are executed between the terminal 100A, the printer 10, the authentication server 200, the connection server 300, and the SP server 400. In the present case, the verification information VE6 and signature information SI6 are used.

As mentioned above, the printer 10 selects the terminal 100A whose second distance is smaller than its first distance from among the terminals 100A to 100C, and sends the fifth Publish signal to the selected terminal 100A. It is likely that the user who is using the terminal whose second distance is smaller than its first distance wishes to execute the FIDO authentication. According to the above configuration, the FIDO authentication can be executed by using the terminal which the user with a high likelihood of wishing to execute the FIDO authentication is using.

### Correspondence Relationships

The fifth Publish signal is an example of “first search signal”.

(First Modification) The “communication device” is not limited to a printer, but may be a scanner, a multifunction machine, for example.

(Second Modification) The “authenticator information” is not limited to the MAC address(es), but may be a contact ID and/or a link ID, for example.

(Third Modification) The BT communication scheme and the BT I/F 20 are examples of “first communication scheme” and “first communication interface”, respectively. A case where the initial state is the same as that of Case C of FIG. 7 will be assumed. In this case, the same processes as T310 to T350 are executed, except T320, T328, T340 of FIG. 7. In the present modification, in T320, T328, T340, instead of the Wi-Fi Aware communication, the BT communication is performed. In the present modification, the distance from the printer 10 may be measured by using a received radio field intensity in the second and third embodiments.

(Fourth Modification) The printer 10 and the terminals 100A to 100C may further comprise an NFC I/F. The NFC I/F is an I/F configured to execute wireless communication according to the NFC scheme. Hereafter, wireless communication according to the NFC scheme will be referred to as “NFC communication”. The NFC scheme is a wireless communication scheme for so-called near field wireless communication, and conforms to an internal standard such as ISO/IEC21481 or 18092. A communication speed of the NFC communication (e.g., maximum communication speed is 424kbps) is slower than the communication speed of the normal Wi-Fi communication. A carrier wave frequency for the NFC communication is 13.56MHz. A maximum distance over which the NFC communication (e.g., approximately 10cm) is possible is shorter than the maximum distance over which the normal Wi-Fi communication is possible. That is, the NFC communication is so-called near field wireless communication.

The NFC communication scheme and the NFC I/F are examples of “first communication scheme” and “first communication interface”, respectively. A case in which an initial state is the same as that of Case C of FIG. 7 will be assumed. In this case, when the NFC connection is established between the printer 10 and the terminal 100A, the same processes as T310 to T350 are executed except T320, T328, T340 of FIG. 7. In the present modification, in T320, T328, T340, instead of the Wi-Fi Aware communication, the NFC communication is executed.

(Fifth Modification) The first Publish signal may be sent to all the devices belonging to the same NAN cluster as the printer 10. That is, the first Publish signal in the present modification is not the signal directed to a device of which distance from the printer 10 is less than the first predetermined distance. In the present modification, even when the first response signal is not received after the first Publish signal has been sent, the printer 10 does not send the second Publish signal. In the present modification, “send, via the first communication interface, a second search signal”, “receive a second response signal” may be omitted.

(Sixth Modification) In the first embodiment, the printer 10 may not send the second Publish signal when the first response signal is not received after the first Publish signal has been sent. In the present modification, “send, via the first communication interface, a second search signal”, “receive a second response signal” may be omitted.

(Seventh Modification) The printer 10 may receive the Advertise signal including “nonce” from the terminal 100A via the BT I/F 20 in T340 in Case C of FIG. 7.

(Eighth Modification) The printer 10 may not comprise the BT I/F 20. In the present modification, the terminal 100A encrypts the WebSocket information to create Wi-Fi Aware Pairing according to Wi-Fi Aware after T32 of FIG. 3. Next, the terminal 100A sends the Wi-Fi Aware Pairing to the printer 10 via the Wi-Fi I/F 22 by using the Wi-Fi Aware communication. Subsequently, the printer 10 acquires the WebSocket information by decrypting the Wi-Fi Aware Pairing with the stored key information. Similarly, the terminal 100B creates Wi-Fi Aware Pairing by encrypting the WebSocket information after T144 of FIG. 5.

(Ninth Modification) The printer 10 sends the service start request including the service URL and the specified token to the SP server 400 in T80 of FIG. 4. In a modification, the printer 10 may send the service URL and the token to the terminal 100A. In the present modification, after the terminal 100A has received the service URL and the token from the printer 10, the terminal 100A sends the service start request including the service URL and the token to the SP server 400, and receives the service screen data from the SP server 400 without intervention of the printer 10.

(Tenth Modification) In the second embodiment, the printer 10 selects the terminal with which is at the shortest distance from the printer 10 after the distance measurement process has been executed. In a modification, M (the M being an integer of two or more) terminals with at the shortest to M-th distance from the printer 10 may be specified from among all the terminals. In the present modification, the third Publish signal includes M pairs of “user name, MAC address”. Here, the “M” may be a fixed value, and also may vary according to the number of the terminals belonging to the same NAN cluster as the printer 10. Although this is an example, the “M” may be half the number of the terminals belonging to the same NAN cluster as the printer 10.

(Eleventh Modification) Although in the above-mentioned embodiments, the processes of FIGS. 3 to 10 are realized by software (e.g., programs 40, 140, 142), at least one of these processes may be realized by hardware such as a logic circuitry.

What is claimed is:

1. A communication device comprising:
a controller;
a first communication interface configured to operate according to a first communication scheme; and
a second communication interface configured to operate according to a second communication scheme different from the first communication scheme; and
a memory configured to store authenticator information and communication information in association with each other for each of a plurality of authenticators, wherein the authenticator information is related to the authenticator and the communication information is related to encrypted communication using the second communication interface between the authenticator and the communication device,
wherein the controller is configured to:
in a case where an authentication start instruction is acquired, send, via the first communication interface, a first search signal including at least one authenticator information among a plurality of the authenticator information in the memory;
in response to the first search signal being sent, receive, via the first communication interface, a first response signal including first authenticator information included in the plurality of the authenticator information from a first authenticator related to the first authenticator information; and
in a case where the first response signal is received, execute, via the second communication interface, the encrypted communication using first communication information stored in association with the first authenticator information, and send, via the second communication interface, an authentication execution instruction to the first authenticator, wherein the authentication execution instruction is information for instructing to execute authentication according to a predetermined authentication scheme which uses a pair of keys and biometric authentication information.

2. The communication device as in claim 1, wherein the first communication scheme is a scheme according to Wi-Fi Aware of a Wi-Fi Standard.

3. The communication device as in claim 2, wherein the first search signal is a signal directed to an authenticator of which distance from the communication device is less than a first predetermined distance, and the first search signal includes the plurality of authenticator information.

4. The communication device as in claim 3, wherein the controller is further configured to:
in a case where no response signal is received after the first search signal has been sent, send, via the first communication interface, a second search signal including the plurality of authenticator information, the second search signal being a signal directed to an authenticator of which distance from the communication device is less than a second predetermined distance that is greater than the first predetermined distance; and
in response to the second search signal being sent, receive a second response signal including second authenticator information included in the plurality of authenticator information from a second authenticator related to the second authenticator information,
wherein the controller is configured to, in a case where the second response signal is received from the second authenticator, execute, via the second communication interface, the encrypted communication using second communication information stored in association with the second authenticator information, and send, via the second communication interface, the authentication execution instruction to the second authenticator.

5. The communication device as in claim 2, wherein the controller is further configured to:
measure a distance between the communication device and each of N authenticators, the N being an integer of 2 or more, and
wherein the controller is configured to select the first authenticator, which is at a shortest distance from the communication device, from among the N authenticators, and send the first search signal including the first authenticator information to the selected first authenticator.

6. The communication device as in claim 2, wherein the controller is further configured to:
measure a first distance between the communication device and each of N authenticators according to the first communication scheme, the N being an integer of 2 or more; and
in a case where a predetermined time elapses since the first distance between the communication device and each of the N authenticators has been measured, measure a second distance between the communication device and each of the N authenticators, and
the controller is configured to select, from among the N authenticators, the first authenticator having the second distance that is smaller than the first distance, and send the first search signal including the first authenticator information to the selected first authenticator.

7. The communication device as in claim 1, further comprising a third communication interface configured to operate according to a third communication scheme different from the second communication scheme,
wherein the controller is further configured to:
in a case where a registration instruction is acquired, receive, via the third communication interface, third communication information from the first authenticator,
wherein the controller is configured to:
in a case where the registration instruction is acquired and the third communication information is received from the first authenticator, execute, via the second communication interface, the encrypted communication using the third communication information, and send, via the second communication interface, the authentication execution instruction to the first authenticator; and
in a case where the authentication start instruction is acquired and the first response signal is received, execute the encrypted communication using the first communication information, and send the authentication execution instruction to the first authenticator even if communication with the first authenticator via the third communication interface is not executed.

8. The communication device as in claim 1, wherein the first communication interface and the second communication interface are physically a single interface.

9. A non-transitory computer-readable recording medium storing computer-readable instructions for a communication device,
wherein the communication device comprises:
a first communication interface configured to operate according to a first communication scheme; and
a second communication interface configured to operate according to a second communication scheme different from the first communication scheme;
a memory configured to store authenticator information and communication information in association with each other for each of a plurality of authenticators, wherein the authenticator information is related to the authenticator and the communication information is related to encrypted communication using the second communication interface between the authenticator and the communication device; and
a processor,
wherein the computer-readable instructions, when executed by the processor, cause the communication device to:
in a case where an authentication start instruction is acquired, send, via the first communication interface, a first search signal including at least one authenticator information among a plurality of the authenticator information in the memory;
in response to the first search signal being sent, receive, via the first communication interface, a first response signal including first authenticator information included in the plurality of the authenticator information from a first authenticator related to the first authenticator information; and
in a case where the first response signal is received, execute, via the second communication interface, the encrypted communication using first communication information stored in association with the first authenticator information and send, via the second communication interface, an authentication execution instruction to the first authenticator, wherein the authentication execution instruction is information for instructing to execute authentication according to a predetermined authentication scheme which uses a pair of keys and biometric authentication information.

10. A method executed by a communication device,
wherein the communication device comprises:
a first communication interface configured to operate according to a first communication scheme; and
a second communication interface configured to operate according to a second communication scheme different from the first communication scheme;
a memory configured to store authenticator information and communication information in association with each other for each of a plurality of authenticators, wherein the authenticator information is related to the authenticator and the communication information is related to encrypted communication using the second communication interface between the authenticator and the communication device,
wherein the method comprises:
in a case where an authentication start instruction is acquired, sending, via the first communication interface, a first search signal including at least one authenticator information among a plurality of the authenticator information in the memory;
in response to the first search signal being sent, receiving, via the first communication interface, a first response signal including first authenticator information included in the plurality of the authenticator information from a first authenticator related to the first authenticator information; and
in a case where the first response signal is received, executing, via the second communication interface, the encrypted communication using first communication information stored in association with the first authenticator information and sending, via the second communication interface, an authentication execution instruction to the first authenticator, wherein the authentication execution instruction is information for instructing to execute authentication according to a predetermined authentication scheme which uses a pair of keys and biometric authentication information.
